(19) United States
(12) Patent Application Publication
(10) Pub. No.: US 2013/0016581 A1
(43) Pub. Date: Jan. 17, 2013

(54) Mixing Device Having a Wear-Resistant Lining

(71) Applicants: Martin Doerr, Walldurn (DE); Wolfgang Worner, Hopfingen-Waldstetten (DE); Stefan Gerl, Werbach (DE); Clemens Schmitt, Walldurn-Altheim (DE); Peter Wagner, Hardheim (DE)

(72) Inventors: Martin Doerr, Walldurn (DE); Wolfgang Worner, Hopfingen-Waldstetten (DE); Stefan Gerl, Werbach (DE); Clemens Schmitt, Walldurn-Altheim (DE); Peter Wagner, Hardheim (DE)

(21) Appl. No.: 13/638,038

(22) PCT Filed: Apr. 15, 2011
(86) PCT No.: PCT/EP11/56005

§ 371 Date: Sep. 28, 2012

(30) Foreign Application Priority Data
Apr. 16, 2010 (DE) 10 2010 027 885.8

(51) Int. Cl. B01F 15/00; B01F 9/10

(52) U.S. Cl. 366/220; 366/349

(57) ABSTRACT

The present invention relates to a mixing device, comprising a vessel for receiving material for mixing, which can be rotated abut a vessel axis and has a discharge opening disposed in the base thereof, a mixing tool disposed in the interior of the vessel, and a closure lid for closing the discharge opening, where the vessel base and/or the closure lid are provided with a wear-resistant lining on the side facing the interior of the vessel. In order to provide a mixing device having a wear-resistant lining which is less prone to wear, and in the event of wear can be replaced more easily and above all more cost-effectively, according to the invention the wear-resistant lining consists of a main lining part and a wear element, wherein the wear element is disposed closer to the vessel axis than the main lining part.

The present invention concerns a mixing device having a wear-resistant lining.

Such mixing devices generally have a container rotatable about a mixer axis for receiving material to be mixed, with a discharge opening arranged in the bottom thereof. In general the discharge opening is arranged in the centre of the bottom. Those mixing devices frequently have a mixing tool arranged in the interior of the container and a closure cover for closing the discharge opening. The mixing container can be for example cylindrical.

A mixer having cylindrical mixing containers which are oriented vertically or slightly inclined in relation to the vertical are usually lined with a wear-resistant lining to at least reduce the wear of the mixing container and the closure cover. Besides small-format ceramic tiles which are glued on to the bottom and the walls of the mixing container, in particular large-format wear-resistant plates of thicker, highly wear-resistant steel sheets, chilled cast iron or hard steel materials or wearing plates with hardfacing thereon are used for that purpose. Those wear-resistant plates are admittedly themselves subjected to wear but they can be easily replaced so that the use of wear-resistant plates provides that the service life of the mixing container and the closure cover can be markedly extended.

In the case of mixing containers with a discharge opening arranged centrally in the container bottom, part-annular wear-resistant plates are releasably fixed on the container bottom between the outside edge of the discharge opening and the container wall or the wear-resistant lining fixed thereto. A circular wear-resistant cover which covers over the entire cross-section of the discharge opening is also releasably fixed on the surface of the closure cover so that, when the closure cover is fitted into the discharge opening, a continuous, flat and wear-resistant surface is formed, which is only interrupted by the gaps which are necessarily formed between adjacent wear-resistant lining elements.

For fixing the wear-resistant plate usually a plurality of round openings are produced by means of a plasma cutter in the plates, into which threaded bushes are then welded. In that way the wear-resistant plates can be fixed in position from below. Particularly in the case of hardfaced wear-resistant plates the particularly wear-resistant wear protection layer has to be removed for that purpose in the region of the opening. Each threaded bush thus represents a point of attack for wearing solids particles. During operation the wear-resistant protective layer is slowly ground away, beginning at the fixing points, until the wear-resistant plates have to be replaced. Each fixing point therefore inevitably results in increased wear of the wear-resistant plate.

In the case of mixtures with a rotating mixing container and a rotating mixing tool blades are generally arranged at the mixing tool bottom, the blades moving over the surface of the container bottom or the wear-resistant surface and thereby keeping the container bottom free from material adhering thereto. The outer region of the container bottom between the container wall and the region over which the bottom blade has just passed is generally cleaned by the rotary movement of the mixing container by way of a stationary bottom scraper which is held in vertically cantilever relationship from above. In that case the bottom blades on the mixing tool are arranged, like the stationary bottom scraper, in such a way that they are at a small spacing relative to the surface of the wear plates and always move over the centre point of the mixing container and keep it free. That results in increased wear in the centre of the discharge opening so that the wear-resistant lining on the closure cover has to be replaced more frequently than the part-annular elements on the container bottom. As the peripheral speed of the bottom blades is generally markedly greater than that of the rotating mixing container the abrasion of the wear-resistant layer increases during operation towards the centre of the mixing container.

As described for example in EP 1 103 492 the closure cover is pivoted into and out of the discharge opening with a circular motion by means of a carrier arm. So that the discharge opening is sealingly closed and the wearing attack by the material to be mixed at the resulting gaps is slight gaps which are as narrow as possible are necessary between the mixing container on the one hand and the wearing cover on the other hand. That means that replacement of the wearing cover is very complicated and expensive. The wearing cover has dimensional tolerances caused by production engineering so that the closure device has to be freshly adjusted in the horizontal and vertical directions by particularly skilled personnel, which is time-consuming.

If the closure cover is pivoted into the discharge opening of the rotating mixing container by way of a circular movement in the closing process then the edge of the closure cover or the wearing cover fixed thereto will hit against the lower edge of the discharge opening. The closure cover can then be deflected slightly out of the circular movement by way of a tilt axis provided in the carrier arm so that the closure cover moves linearly into the discharge opening. Contact of the closure cover with the discharge opening surrounding same ensures that the rotary movement of the mixing container is transmitted to the closure cover which is provided with a mounting arrangement so that in the closed condition the closure cover also rotates with the mixing container in slippage-free relationship. The hooking engagement of the closure cover into the discharge opening provides that the inside of the annular discharge opening becomes worn with time and also has to be replaced. Therefore it is already usual for the edge of the discharge opening which in each closing operation comes into engagement with the closure cover to be provided with a separate wear-resistant and replaceable reinforcing ring.

Taking the described state of the art as the basic starting point therefore the object of the present invention is to provide a mixing device having a wear-resistant lining, which wears less severely and which in the event of wear can be replaced more easily and in particular less expensively.

That object is attained by a mixing device of the kind set forth in the opening part of this specification, in which the wear-resistant lining comprises a main lining portion and a wearing element, wherein the wearing element is arranged closer to the container axis than the main lining portion. According to the invention therefore the wear-resistant lining is divided into an element which is loaded more greatly during operation, the so-called wearing element, and an element which is loaded less heavily in operation, the main lining portion. In general, when the wear-resistant lining itself presents wear phenomena, only the wearing element but not the main lining portion has to be replaced.

In a preferred embodiment it is provided that the main lining portion has at least two and preferably at least three fixing bores, arranged on a bolthole circle, the main lining portion has an opening for receiving the wearing element, the wearing element has at least one and preferably at least three fixing bores, wherein the fixing bores of the wearing element are arranged on the bolthole circle when the wearing element is fitted into the opening.

In the case of existing mixing devices with wear-resistant lining it is mostly fixed to the container bottom or the closure cover by means of screws engaging into suitable threaded bushes in the wear-resistant lining.

The described measure makes it possible to use the multi-part wear-resistant lining according to the invention in already existing mixing devices without fresh bores having to be introduced into the container bottom. In addition the bolthole circuit in the existing mixing devices is generally so positioned that optimum fixing of the wear-resistant lining is possible at the fixing locations. In a preferred embodiment therefore it is provided that exactly the same fixing points are used. In addition the use of the usual fixing points enjoys the advantage that the number of fixing bores for the wearing element does not have to be increased, that is to say the number of points exposed to increased wear is not increased.

In a further preferred embodiment it is provided that at its side towards the main lining portion the wearing element is of a concave configuration at least portion-wise, at its side towards the wearing element the main lining portion is of a convex configuration at least portion-wise, wherein the concave portion of the wearing element and the convex portion of the main lining portion are of mutually corresponding configuration. That measure is advantageous in particular when the wearing element and the main lining portion are fixed on the same bolthole circle as then that measure provides that the area covered by the wearing element is reduced so that the costs of manufacture of the wearing element are reduced.

In a further preferred embodiment it is provided that the main lining portion and the wearing portion overlap at least portion-wise at the mutually facing edges, wherein preferably the edges are of such a configuration that the main lining portion and the wearing portion adjoin each other in substantially flush relationship. Thus it is possible for example for the edges to converge conically or to be of a stepped configuration so that both edges engage into each other without the substantially flat surface formed by the wear-resistant lining being interrupted.

Because one of the parts overlaps the other part at the edge, that provides an additional holding action for the part, the edges of which are covered by the edge of the other part. By virtue of that measure, it is possible to save on fixing bores, which in turn increases the service life of the wear-resistant lining since, as already mentioned in the opening part of this specification, each fixing bore represents a point involving increased wear.

In that respect the edges are advantageously of such a configuration that the edge of the wearing element extends over the edge of the lining element so that the main lining portion is held by the wearing element. In an alternative embodiment the two edges can also be of a design configuration in the manner of a groove-and-tongue connection.

In a further preferred embodiment at the side towards the container interior the container bottom is provided with a wear-resistant lining comprising the main lining portion and the wearing element, wherein the wearing element is of a stepped configuration at its side towards the discharge opening so that the wearing element at least portion-wise covers over the inner edge of the discharge opening.

As already mentioned in the opening part of this specification the inner edge of the discharge opening, in some mixing devices, serves at the same time as an abutment and guide for the closure cover held on a carrier arm. Consequently the inner edge of the discharge opening is exposed to increased wear. Because the closure element is of a stepped configuration so that it also at least partially covers the inner edge of the discharge opening, no further measures are necessary to protect the inner edge of the discharge opening.

Alternatively or in combination thereof at the side towards the container interior the closure cover can be provided with a wear-resistant lining comprising the main lining portion and the wearing element, wherein the main lining portion is of a stepped configuration at its side towards the edge of the closure cover so that the main lining portion at least portion-wise covers over the edge of the closure cover.

With that feature the edge of the closure cover can also be protected and in the event of wear the wearing element can be easily replaced.

It is further advantageous if at the side towards the container interior the container bottom is provided with a wear-resistant lining comprising the main lining portion and the wearing element and the container wall is provided with a wear-resistant lining which does not extend to the container bottom so that a gap remains at least portion-wise between the wear-resistant lining of the container wall and the container bottom, into which gap the main lining portion projects at least partially.

The main lining portion is thus inserted between the wear-resistant lining of the container wall and the container bottom so that the wall lining holds the main lining portion in the region of the container wall. It is now therefore only still necessary to fix the main lining portion at the opposite side, that is to say the side towards the wearing element. If for example the wearing element and the main lining portion are of a corresponding stepped configuration at the mutually facing edges, as was described hereinbefore, it is then possible to completely dispense with an additional screw fixing for the main lining portion, and that markedly increases the service life of the main lining portion, especially as it is in any case according to the invention arranged in a region exposed to only slight wear. In addition it is possible for the container wall to have at least one aperture and for the main lining portion to be of such a configuration that it extends through the aperture in the container wall. That feature can also provide that the main lining portion is fixed in the region of the container wall.

As however the thickness of the wear-resistant lining is subjected to certain tolerances, optimum dimensioning of the container wall aperture is not possible. If the aperture is too small, then depending on the wear-resistant lining production tolerance, the main lining portion can possibly no longer extend through the aperture. If in contrast the aperture is too large the aperture or the container wall can no longer securely support the main lining portion.

In a preferred embodiment it is therefore provided that a clamping device is arranged outside the container in such a way that the clamping device can come into engagement with the portion of the main lining portion, that projects through the aperture in the container wall, and can press the main lining portion on to the container bottom. With this embodiment the container wall aperture can be larger as it is now no longer intended for holding the main lining portion.

The main lining portion may also be of a multi-part nature, wherein the parts of the main lining portion are arranged in the peripheral direction, wherein preferably the mutually adjoining edges of two adjacently arranged parts of the main lining portion are not arranged exactly radially. Frequently the described mixing devices more specifically use a bottom scraper arranged exactly radially relative to the container axis. If the gaps between adjacent parts of the main lining portion are also arranged exactly radially that leads to periodic increases in the resistance that the scraper has to overcome, and that leads to increased wear of the scraper. The fact that the gaps between mutually adjoining parts of the main lining portion do not extend radially but for example in angled or rounded relationship provides that such periodically occurring shock forces can be avoided.

Further advantages, features and possible uses of the present invention will be clearly apparent from the description hereinafter of preferred embodiments and the accompanying Figures in which:

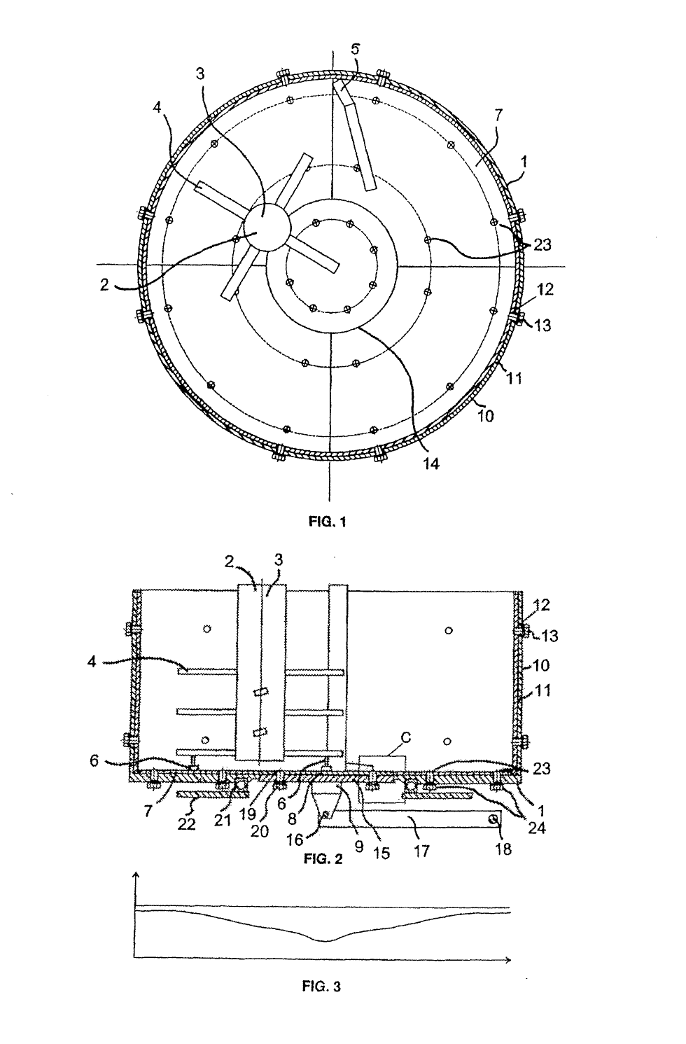

FIG. 1 shows a plan view of a mixing container of the state of the art,

FIG. 2 shows a sectional view of a mixing container of the state of the art,

FIG. 3 shows a diagrammatic wearing profile on the container bottom in embodiments in the state of the art,

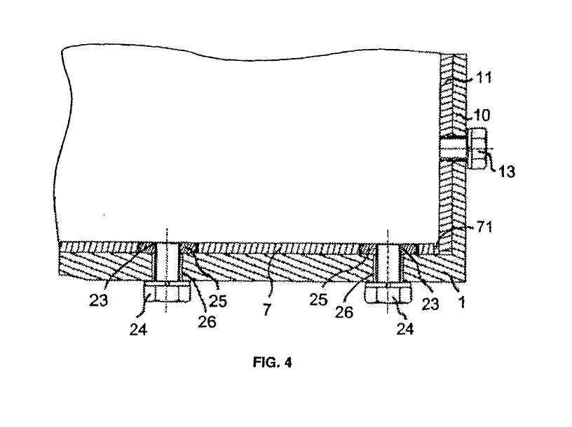

FIG. 4 shows a detail view of a corner of a mixing container in the state of the art,

FIG. 5 shows a first embodiment of the invention,

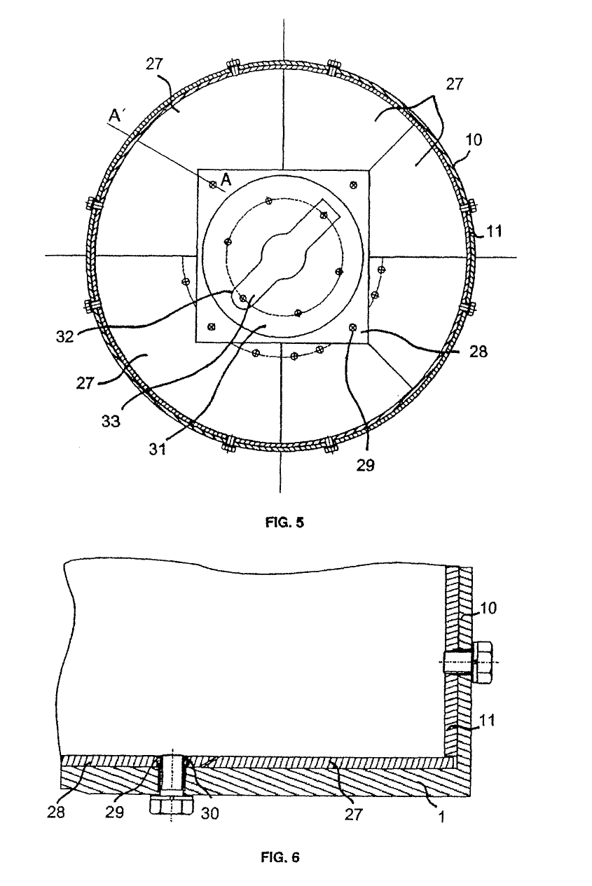

FIG. 6 shows a detail view of FIG. 5 along section line A-A′,

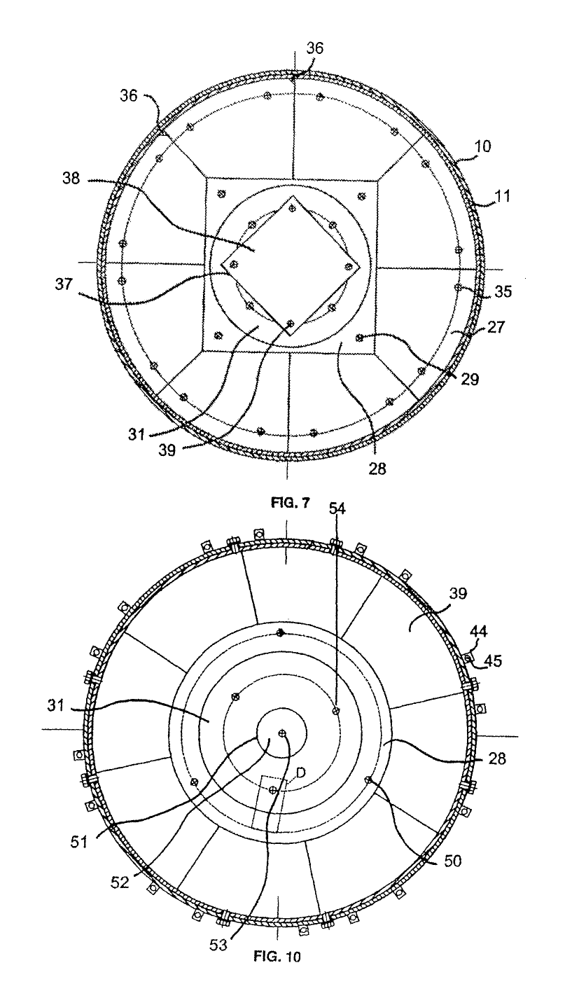

FIG. 7 shows a second embodiment of the invention,

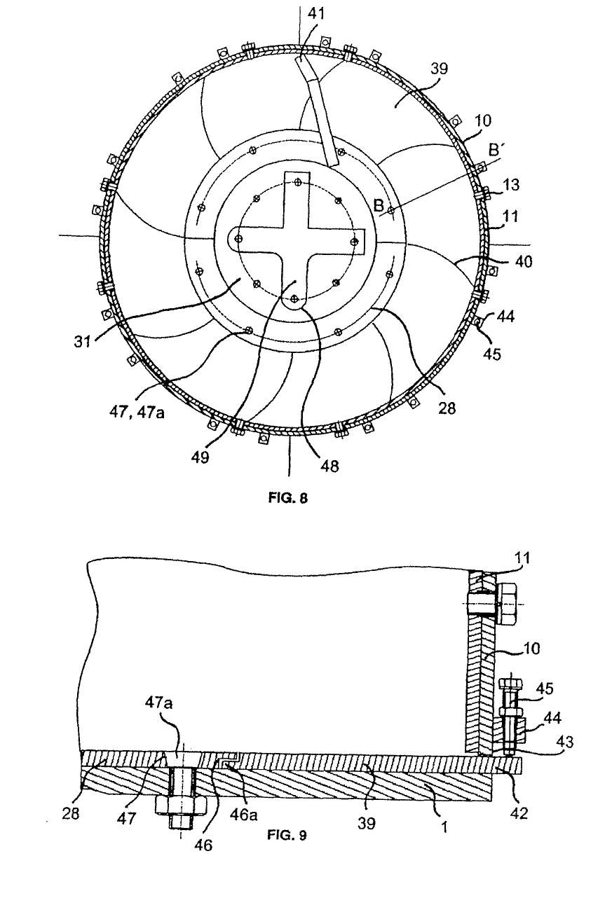

FIG. 8 shows a third embodiment of the invention,

FIG. 9 shows a detail view of FIG. 8 along section line B-B′,

FIG. 10 shows a fourth embodiment of the invention,

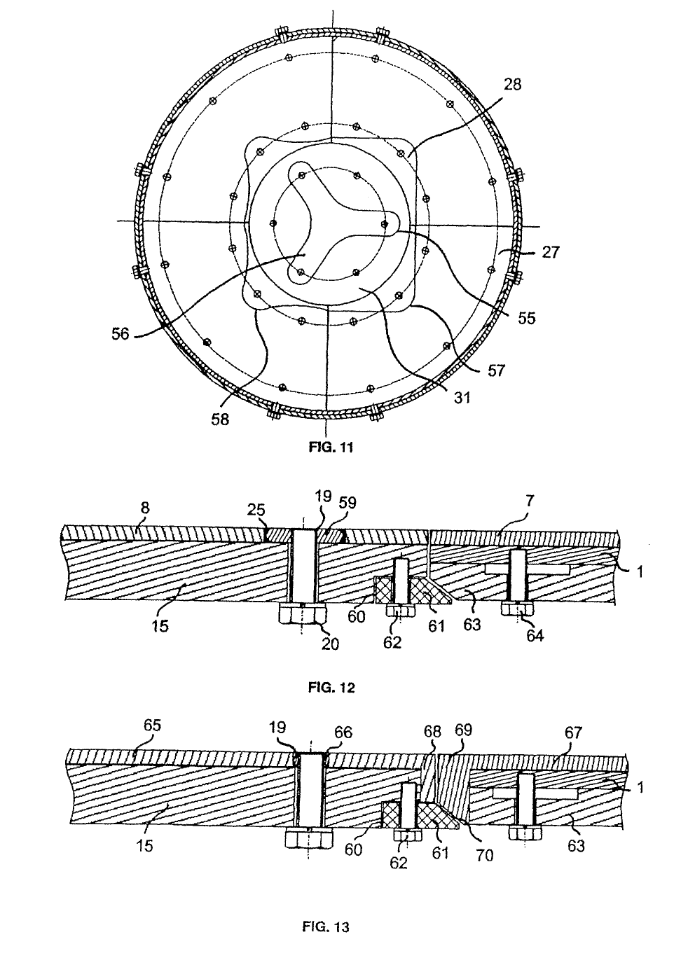

FIG. 11 shows a fifth embodiment of the invention,

FIG. 12 shows a detail view of the portion C in FIG. 2, and

FIG. 13 shows a detailed cross-sectional view of the portion D in FIG. 10.

FIG. 1 shows a plan view of a mixing container with wear-resistant lining, as is known from the state of the art. FIG. 2 shows a sectional view and FIG. 4 shows a detail view on an enlarged scale.

The cylindrical mixing container 1 has a mixing tool 2 which is arranged eccentrically in the mixing container and which is supported in cantilever relationship, on a central shaft 3, with laterally arranged mixing vanes 4, and a stationary wall/bottom scraper 5 which is held in cantilever relationship vertically from above. Fixed to the lowermost vane plane of the mixing tool 2 are vertically downwardly projecting bottom blades 6 which operate at a small spacing relative to the surface of the wearing plate 7 or the wearing cover 8 of the closure device 9. Curved wearing surfaces 11 with incorporated threaded bores 12 are releasably fixed by way of screws 13 to the inside wall 10 of the container 1.

The discharge opening 14 is in the centre of the mixing container 1. The discharge opening 14 can be closed with the closure cover 15 mounted on the closure device 9. The closure cover 15 is connected to a carrier arm 17 by way of a mounting fork and the mounting journal 16 and is thus pivotable about the tilt axis of the mounting journal 16. The carrier arm 17 is rotatably mounted by way of a pivotal shaft 18. A return element (not shown) provides that, without the actions of external forces, the closure cover 15 assumes a given position relative to the carrier arm 17.

A one-piece round wearing cover 8 is releasably connected on the top side of the closure cover 15 to at least three threaded bores 19 arranged on at least one bolthole circle by means of screws 20.

Wearing plates 7 are provided in the form of ring segments on the container bottom. There is a small annular gap between the wearing cover 8 on the one hand and the inside edge of the wearing plates 7 on the other hand. The part-annular wearing plates 7 are provided, similarly to the wearing cover 8, with incorporated threaded bores 23 which are disposed on an inner and an outer bolthole circle, and are releasably fixed from below by way of screws 24. The radially outer edge of the wearing plate 7 is of a smaller radius than the inside radius of the wearing surface 11 fixed to the container wall 10. The mixing container 1 is mounted rotatably on the machine frame 22 by way of a rotational connection 21 and is caused to rotate by way of a drive (not shown).

FIG. 3 diagrammatically shows a wearing profile over the diameter of the container.

It will be seen that the wear is at its greatest in the centre of the container and decreases, in relation to moving further outwardly. While the wear in the radially outer region of the mixing container 1 due to the rotational movement in conjunction with the stationary wall/bottom scraper 5 is more or less uniform the wear increases progressively towards the container centre. The highest wear is then observed in the centre of the discharge opening 14.

FIG. 4 shows a detail view of a corner of the mixing container of FIGS. 1 and 2. Part-annular wearing plates 7 are placed on the bottom of the mixing container 1. Openings 25 are provided in the wearing plates, into which are welded inlays with threaded bores 23. The wearing plates 7 are fixed from below through bores 26 in the mixing container 1 by means of screws 24 by way of the threaded bores 23. The wall wearing plates 11 are fixed to the mixing container wall 10 in a similar way. The wall wearing plates 11 extend in that case from the container bottom to almost the upper edge of the mixing container 1. A small gap 71 is formed between the wearing plates 7 and the wall wearing plate for production engineering reasons.

FIG. 5 shows a plan view of a first embodiment of the invention and FIG. 6 shows a sectional view along line A-A′.

Here the container wall 10 is lined with curved and releasably connected wearing surfaces 11 of known kind. It will be noted however that the lower edge of the wearing surface 11 is no longer on the mixing container bottom but is arranged above the bottom by at least the height of the wearing plate 27. Here the wearing plates comprise the main lining portions 27 and the wearing element 28. The main lining portion 27 does not have any opening or threaded bore and is bevelled at the radially inner edge. In the same manner at its radially outer edge the wearing element 28 has an oppositely extending edge. The square wearing element 28 shown in FIG. 5 is provided in the four corner regions with bores 29 which are cut by means of a laser and into which threaded bushes 30 are welded at the rear side. The laser-cut bores are only slightly larger than the threaded bush so that there is only a quite small gap between the fixing means and the wear-resistant layer. The wearing element 28 is releasably fixed on the mixing container bottom by way of screw connections introduced through the mixing container bottom from below, and by way of the bevel configuration holds the main lining portion 27 at the radially inner edge thereof. At the radially outer edge the main lining portion 27 is pushed under the lower edge of the wall wearing plate 11 and held down from above by same. As an alternative thereto the wall wearing plate 11 can also be introduced into the mixing container after fitment of the main lining portion 27 and fixed to the container wall 10. If required spacers which are variable in thickness can additionally be introduced in point relationship between the radially outer edge of the main lining portion 27 and the inner container wall 10 to prevent movement of the main lining portion radially outwardly.

A variant of this embodiment is shown in the lower half of FIG. 5. More specifically here the main lining portions are releasably connected with screws in the region of their radially inwardly disposed edges by means of bores 34 to threaded bushes which are welded in position at the underside of the mixing container bottom. In this case the radially outwardly disposed edge of the wearing element 28 and the radially inwardly disposed edge of the main lining portion 27 do not have to be in overlapping relationship. It will be seen that the fixing bore 29 of the wearing element 28 is on the same bolthole circle as the fixing bores of the main lining portion 27. It is advantageous in particular when retrofitting existing mixing devices with the lining according to the invention as here the bolthole circle already present in the container bottom can be used for fixing both the wearing element 28 and also the main lining portions 27.

As it has been found that in operation the greatest wear of the wear-resistant lining occurs in the proximity of the discharge opening it is sufficient, with an embodiment according to the invention, to replace only the wearing element 28 while the main lining portions 27 can initially continue to be used further. While in the configurations in the state of the art, the complete wear-resistant lining would have to be replaced in the event of any wear, the invention provides that the main lining portions 27 can be re-used at least once but preferably a number of times before they have to be replaced.

The wear-resistant lining of the closure cover is also of a multi-part nature and comprises a main lining portion 31 and a wearing element 33, wherein the wearing element 33 embraces the inner region of the wear-resistant lining of the closure cover. Thus in this case also the region which is most severely affected by wear is provided at the centre with a separate wearing element 33 which in a wear situation can be replaced while the main lining portion 31 can remain on the closure cover. That has the advantage in particular that no re-adjustment of the carrier arm or the wearing system is involved, which is absolutely necessary when replacing also the main lining portion 31.

In the embodiment shown in FIG. 5 the main lining portion 31 is of a substantially circular configuration, having a rectangular cut-out 32 which is widened in the centre. The cut-out 32 can have angular or rounded-off corners, as diagrammatically shown. A wearing element 33 is fitted in accurately fitting relationship in the cut-out 32 and is releasably connected by way of two bores arranged in the oppositely disposed end regions of the wearing element 33, with a screwthread or with welded-in threaded bushes, on the bolthole circle of the main lining portion 31, by way of suitable screw connections. In that way the inner region 33 of the wear-resistant lining, that is most severely affected by wear, can be replaced without the remaining region 31 which is less affected by wear having to be replaced. As the cut-out 32 does not extend to the outer edge of the wearing cover, when replacing the inner part the remaining wear-resistant lining will remain fixedly connected to the closure device by way of the screw means. Accordingly there is no longer any need for re-alignment of the closure device after replacement of the inner portion.

FIG. 7 shows a second embodiment of the invention. In this embodiment fixing of the main lining portions 27 of the container bottom is effected at the radially outer end thereof by way of the above-described laser-cut bores 35 arranged on a bolthole circle with welded-in threaded bushes by a releasable screw connection from below through the mixing container bottom. The outer edge of the main lining portions 27 is not covered over and held down by the wall wearing plates 11. For removal of the main lining portions openings 36 which for example can be triangular are provided at the radially outward corners of the ring segments, by means of which openings the main lining portions can be pressed upwardly at the outer edge by way of a lever tool. In this case also the main lining portions 27 are provided at their radially inward edges with a bevel or stepping so that they are held by the outer edge of the wearing element 28. In this embodiment the wearing element 38 of the wear-resistant lining of the closure cover is of a square configuration. The wearing element 38 is releasably connected to the closure device 9 by way of four bores 39 provided at the outer corners. In this case the bores are disposed on the same bolthole circle as the bores for fixing the main lining portion 31 of the wear-resistant lining of the closure cover.

A third embodiment of the invention is shown in FIG. 8 as a plan view and in FIG. 9 as a sectional view along section line B-B′.

Here the main lining portions 39 have an outer edge 40 of a curved configuration. A particular advantage of this embodiment is that the main lining portions only have to involve a single geometry and this is the case even with segment angles of <90°. In addition, the curved butting edge assists with material entrainment of the material to be mixed which is disposed in the mixing container, particularly upon rotation of the mixing container in the clockwise direction. A further advantage of this geometry is that for example a bottom scraper 41 which is mounted in cantilever relationship and which extends radially from the outside inwardly only has a point contact at its outer edge with the gap and no longer a line contact so that this avoids hooking engagement of jammed solids particles in the gap and thus increased wear.

Disposed at the radially outer edges of the main lining portions 39 are tongues 42 which can be passed through suitable openings 43 in the container wall 10. In this case the lower edge of the wall wearing plates 11 is arranged so far above the mixing container bottom that the main lining portions 39 can be pushed through with the tongues 42. The main lining portions 39 are then held in the vertical direction by the openings 43 in the container wall 10. It is also possible, as shown in FIG. 9, to provide a clamping device on the outside of the container wall 10 above the opening 43, for example the illustrated holder 44 with threaded bore, through which screws, for example pressing screws 45, can be introduced vertically from above to hold down the main lining portions 39 by way of the tongues 42.

The advantage with this structure is that the opening 43 can be of generous dimensions in its vertical extent and even in the event of manufacture-induced fluctuations in the thickness of the hardfaced main lining portions 39 the latter can be firmly held down in the vertical direction on the surface of the container bottom.

The wearing element 28 is of an annular configuration in this variant. Depending on the respective machine size, it can be of a single-part or multi-part nature. At its radially outer edge the wearing element 28 has a stepped recess 46 which overlaps with the correspondingly designed stepped recess 46a at the radially inward edge of the main lining portion 39. Arranged on a bolthole circle in the wearing element 28 are conical openings 47 through which screws with a conical screw head 47a can be fitted without a gap and can be releasably clamped by way of nuts to the container bottom from below the mixing container. The main lining portion is held fast at the inner edge by the overlap at the butting edge between the wearing element 28 and the main lining portion 39. In this variant, no openings at all are required for fixing purposes in the outer bottom region of the mixing container, that is to say for the main lining portions, so that here an uninterrupted wearing layer is exposed to wearing attack and is therefore markedly more wear-resistant. In addition, depending on the respective geometrical configuration, with for example a one-piece configuration, with a total of only three releasable connections, the wearing element 28 can be fixed with a minimum number of fixing points over the entire periphery.

The circular wear-resistant lining of the closure opening comprises a circular main lining portion 31 in which a cross-shaped opening 48 with angular or rounded-off corners is provided, into which a corresponding cross-shaped wearing element 49 is inserted in accurately fitting relationship and releasably fixed there. In that case the bores for fixing the wearing element 49 are preferably disposed on the same bolthole circle as the bores for fixing the main lining portion 31, but can also be arranged at any other desired point.

A variant of the FIG. 8 embodiment is shown in FIG. 10. The main lining portions 39 in the form of segments of a circular ring have straight side edges. As in the FIG. 8 embodiment fixing of the radially outward edges is effected by way of tongues and openings in the container wall. The annular one-piece closure element 28 is releasably fixed on the container bottom by way of three points 50. The wear-resistant lining of the closure cover comprises a circular main lining portion 31 with a centrally arranged circular opening 51 in which a corresponding circular wearing element 52 is held by way of a releasable connection in the centre 53 on the surface of the closure device. To avoid screw heads which are exposed to wear, a threaded pin could be welded at the back in the centre of the circular wearing element 52 and can be screwed by way of the rotary movement of the entire wearing element 52 into a thread in the holding plate 15 or when there is a through bore in the holding plate 15, it can be fixed from the rear side thereof by way of a nut.

As an alternative thereto for fixing a wearing element a threaded bush could be fitted on the rear side of the wearing element and welded thereto, brazed thereto or bonded thereto, without in that case an aperture having to be provided in the wearing element. The threaded bush is smaller in its outside diameter than the diameter of the bore in the bottom of the mixing container 1 or the holding plate of the closure cover 15 and upon assembly projects into same. The wearing element can thus be releasably connected from the rear side of the mixing container or the closure cover by way of screws without the wearing surface in the container interior being damaged.

A comparable fixing method could equally be used for the main lining portions. In this particularly preferred variant for fixing the wearing element and the main lining portions no opening whatsoever would be necessary in the entire surface of the wear-resistant lining and that would entail an uninterrupted wearing layer.

The main lining portion 31 is also releasably fixed on the closure device by way of three fixing points 54 preferably arranged on a bolthole circle.

FIG. 11 shows a further embodiment. Here the wearing element 56 of the wear-resistant lining of the closure cover is in the form of a 3-wing boomerang and is releasably connected to the closure device by way of three fixing points. It will be appreciated that, besides the mentioned releasable connection, a non-releasable connection is also possible, for example by bonding or spot welding.

As can also be seen from FIG. 11 the wearing element 28 of the wear-resistant lining of the container bottom, instead of being square, can also be formed with rounded-off corners 57 and with outside edges 58 which bend in an arcuate or curved shape. It will be appreciated that the main lining portions 27 should be of a corresponding configuration at their radially inward edge.

In principle no limits are placed on the geometrical configuration of both the outer edge of the wearing element and also the radially inner edge of the main lining portion. In a further configuration of the invention the inside edge of the discharge opening, that is exposed to wear, is integrated into the wearing element 67 which lies on the mixing container bottom so that additional fitment operations when replacing the reinforcing ring can be eliminated. In addition the outer edge of the wearing cover of the closure device can be adapted by way of a particular geometrical configuration to resist wearing attack upon closure of the closure device.

For illustration purposes FIG. 12 shows the portion C from FIG. 2 of the state of the art while FIG. 13 shows the portion D in FIG. 10. A wearing cover 8 with at least two openings 25 is arranged on the closure cover 15 of the closure device 9 in FIG. 12. Welded into the openings 25 is an inlay 59 having a threaded bore 19, the wearing cover 8 is releasably connected from beneath the holding plate 15 by means of screws thereto. On its outer periphery the closure cover 15 forms a stepped recess 60 into which an annular rubber seal 61 is releasably introduced by means of screws 62 distributed around the periphery. The radially outward end of the rubber seal 61 projects somewhat and is bevelled so that in the closed condition of the closure device it seals with the oppositely configured bevel of a reinforcing ring 63 which is releasably connected to the mixing container bottom 1 beneath same by way of a screw connection 64. A wearing plate 7 is fixed on the top side of the mixing container bottom.

FIG. 13 shows the improved configuration according to the invention. Arranged on the closure cover 15 of the closure device 9 is a wearing element 65 having at least two openings 66 into which threaded bushes 19 are welded from the rear side of the wearing element 65. As the opening 66 is markedly reduced in comparison with the openings 25 in the state of the art, wearing attack by the material being mixed and the blades is also markedly reduced.

At its radially outward end the wearing element 65 has an edge 68 which is angled in a L-shape and which covers over the radially outer part of the closure cover 15. The surface of the edge which is angled in a L-shape, like the flat surface of the main lining portion, can comprise the same or a different wear-resistant material or a hardfaced surface. The closure cover 15 is reduced in diameter to correspond to the thickness of the L-shaped edges. On its outer periphery the closure cover 15 has a stepped recess 60 into which an annular rubber seal 61 is releasably introduced by means of screws 62 distributed over the periphery. The radially outer end of the rubber seal 61 projects beyond the edge and is bevelled. Fixed on the mixing container bottom 1 is a wearing element 67 which also has at its radially inner end an edge 69 which is angled in a L-shape. The outer end of the angled edge 70 is bevelled to correspond to the rubber seal so that in the closed condition of the closure device the rubber seal sealingly closes the gap between the closure device and the mixing container. That arrangement according to the invention provides that the inside edge of the reinforcing ring, that is particularly loaded in the closing operation, is also replaced upon replacement of the worn wearing element 67. As fixing is effected together with the wearing element 67 additional fitment of a reinforcing ring is eliminated.

List of references
1 cylindrical mixing container
2 mixing tool
3 central shaft
4 mixing vanes
5 wall/bottom scraper
6 bottom blade
7 wearing plate
8 wearing cover
9 wearing device
10 inside wall of the container
11 curved wearing surfaces
12 threaded bores
13 screws
14 discharge opening
15 closure cover
16 journal
17 carrier arm
18 pivot shaft
19 threaded bores
20 screws
21 rotary connection
22 machine frame
23 threaded bores
24 screws
25 openings
26 bores
27 main lining portion
28 wearing element
29 bores
30 threaded bores
31 main lining portion
32 rectangular cut-out
33 wearing element
35 laser-cut bores
36 openings
38 wearing element
39 main lining portion
40 outer edge
41 bottom scraper
42 tongues
43 opening
44 holder
45 pressure screws
46 stepped recess
46a stepped recess
47 conical openings
47a conical screw head
48 cross-shaped opening
49 wearing element
50 points
51 circular opening
52 circular wearing element
53 centre on the surface of the closure device
54 fixing points
56 wearing element
57 rounded-off corners
58 curved outside edges
59 inlay
60 stepped recess
61 annular rubber seal
62 screws
63 reinforcing ring
64 screw connection
65 wearing element
66 openings
67 wearing element
69 edge angled in a L-shape
70 angled edge
71 gap

1. A mixing device comprising a container rotatable about a container axis for receiving material to be mixed, in the bottom of which is arranged a discharge opening (14), a mixing tool (2) arranged in the interior of the container and a closure cover for closing the discharge opening, wherein the container bottom and/or the closure cover is provided with a wear-resistant lining at the side towards the container interior, characterised in that the wear-resistant lining comprises a main lining portion (31) and a wearing element (28), wherein the wearing element (28) is arranged closer to the container axis than the main lining portion (31).

2. A mixing device according to claim 1 characterised in that the main lining portion (31) has at least two and preferably at least three fixing elements, for example fixing bores, arranged on a circle, for example a bolthole circle, the main lining portion (31) has an opening for receiving the wearing element, the wearing element (28) has at least one and preferably at least three fixing elements, for example fixing bores, wherein the fixing elements of the wearing element are arranged on the circle when the wearing element is fitted into the opening.

3. A mixing device according to claim 1 or claim 2 characterised in that at its side towards the main lining portion (31) the wearing element (28) is of a concave configuration at least portion-wise, at its side towards the wearing element (28) the main lining portion (31) is of a convex configuration at least portion-wise, wherein the concave portion of the wearing element and the convex portion of the main lining portion (31) are of mutually corresponding configuration.

4. A mixing device according to one of claims 1 to 2 characterised in that the main lining portion (31) and the wearing portion overlap at least portion-wise at the mutually facing edges, wherein preferably the edges are of such a configuration that the main lining portion (31) and the wearing portion adjoin each other in substantially flush relationship.

5. A mixing device according to claim 4 characterised in that the edges of the main lining portion (31) and the wearing element (28) are of such a configuration in the overlap region that the edge of the wearing element projects over the edge of the lining element so that the main lining portion (31) is held by the wearing element (28).

6. A mixing device according to one of claims 1 to 2 characterised in that at the side towards the container interior the container bottom is provided with a wear-resistant lining comprising the main lining portion (31) and the wearing element (28), wherein the wearing element (28) is of a stepped configuration at its side towards the discharge opening (14) so that the wearing element (28) at least portion-wise covers over the inner edge of the discharge opening (14).

7. A mixing device according to one of claims 1 to 2 characterised in that at the side towards the container interior the closure cover is provided with a wear-resistant lining comprising the main lining portion (31) and the wearing element (28), wherein the main lining portion (31) is of a stepped configuration at its side towards the edge of the closure cover so that the main lining portion (31) at least portion-wise covers over the edge of the closure cover.

8. A mixing device according to one of claims 1 to 2 wherein at the side towards the container interior the container bottom is provided with a wear-resistant lining comprising the main lining portion (31) and the wearing element (28) and the container wall is provided with a wear-resistant lining, characterised in that the wear-resistant lining on the container wall does not extend to the container bottom so that a gap remains at least portion-wise between the wear-resistant lining of the container wall and the container bottom and the main lining portion (31) projects at least partially into said gap.

9. A mixing device according to one of claims 1 to 2 wherein at the side towards the container interior the container bottom is provided with a wear-resistant lining comprising the main lining portion (31) and the wearing element (28) characterised in that the container wall has at least one aperture and the main lining portion (31) is of such a configuration that it projects through the aperture in the container wall.

10. A mixing device according to claim 9 characterised in that a clamping device is arranged outside the container in such a way that the clamping device can come into engagement with the portion of the main lining portion (31), that projects through the aperture in the container wall, and can press the main lining portion (31) on to the container bottom.

11. A mixing device according to one of claims 1 to 2 characterised in that the main lining portion (31) is of a multi-part nature, wherein the parts of the main lining portion (31) are arranged in the peripheral direction, wherein preferably the mutually adjoining edges of two adjacently arranged parts of the main lining portion (31) are not arranged exactly radially.

12. A wear-resistant lining for use in a mixing device according to one of claims 1 to 2.

13. A wear-resistant lining according to claim 12 characterised in that the wearing element is of a multi-part nature.
